(19) United States
(12) Patent Application Publication
(10) Pub. No.: US 2010/0176168 A1
(43) Pub. Date: Jul. 15, 2010

(54) Collapsible, Three-Wheeled Trolley for Shopping Bags

(75) Inventors: Victor Taranto, Albert Park (AU); Keith McArthur, Carrum Downs (AU)

Correspondence Address: SEED INTELLECTUAL PROPERTY LAW GROUP PLLC, 701 FIFTH AVE, SUITE 5400, SEATTLE, WA, 98104, US

(73) Assignee: Vic-Mack Worldwide Pty. Ltd, Carrum Downs (AU)

(21) Appl. No.: 12/225,992

(22) PCT Filed: Oct. 5, 2006
(86) PCT No.: PCT/AU2006/001444

§ 371 Date: Oct. 3, 2008

(30) Foreign Application Priority Data
Oct. 7, 2005 (AU) 2005905517

(51) Int. Cl. B60R 7/00; B62B 3/12

(52) U.S. Cl. 224/411; 280/651

(57) ABSTRACT

A shopping trolley has a folding and telescoping frame carried by three wheels. A telescopic rod, a part-circle in shape, carries a handle at its upper end and a front wheel at its lower end. From saddles on this rod, shopping bags with stiffened openings can be hung. Pivotted to the curved rod is a leg carrying two rear wheels each on a respective, pivoting arm. Sliding movement of a collar along the leg, combined with telescoping of the curved rod, serve to collapse the trolley for storage.

### BACKGROUND

1. Technical Field

The present invention related to trolleys, and has particular, though not exclusive, application to trolleys suitable for carrying bags, such as shopping bags.

2. Description of the Related Art

For many years since the advent of Supermarkets, shoppers have had to withstand the rigors of using Supermarket supplied metal shopping trolleys that are usually heavy and unwieldy, often becoming unmanageable in small areas and sloping surfaces like car parks and footpaths. Because of their construction the heavy metal Supermarket trolleys often cause damage to property (for instance cars parked in shopping centers) when loss of control by users occurs. Often because of having only one or two large metal baskets in their design, users of the Supermarket Trolleys that are currently deployed at most shopping locations, will need to bundle all of their groceries together. This bundling of groceries is often accompanied by breakages (eggs and other liquids etc.) that can permeate into other grocery items.

The use of many existing trolley mechanisms prolong and add to environmental damage. As an example of environmental damage associated to the Supermarket retail industry, it is said that Australians use 6.9 billion plastic (environmentally unfriendly) bags per year, of which 50-80 million end up in our environment as rubbish and in our waterways.

### BRIEF SUMMARY

Carry-Master trolley addresses this issue and other problems currently associated with Supermarket trolleys.

Carry-Master is a personal shopping trolley which provides shoppers with more features than the current designs of shopping trolleys.

Carry-Master is a very light “foldaway” trolley which allows shoppers to take it to and fro from the supermarket alleviating the need for plastic bags.

It is of simple and attractive design and the materials used in its manufacture ensure its longevity.

It has great practical appeal and is not limited to just one specific market or use. Storage (unloaded) weight is less than 2 kilograms which means it can be used by all age groups. People with disabilities will find an advantage using Carry-Master.

The trolley allows inner city inhabitants to walk their loaded trolley home comfortably and large scale use of the invention will allow supermarkets to reduce prices as they can cut down on trolley provision and losses.

Although many designs have taken up the challenge of the supermarket trolley—this invention will meet the requirements of both supermarkets and individual users.

When not in use the invention folds and collapses by its telescopic action into an easily stored size of less than a meter in length and has a width and breadth which is no greater than the greatest width of the handle bar (as in FIG. 1). The invention can easily be stored in cupboards or vehicle storage areas as the weight is less than two kilograms. The invention is preferably made from lightweight aluminum however other materials can be used in manufacture. For example plastics or carbon fiber based compounds that will give rigidity and support qualities similar to aluminum.

### BRIEF DESCRIPTION OF THE SEVERAL VIEWS OF THE DRAWINGS

FIG. 1 is an isometric drawing of the Carry Master Trolley in its folded state without the carry bags attached.

FIG. 2 is an isometric drawing of the extended frame of the trolley showing the support mechanism of the frame consisting of bars locked into their positions for normal trolley use.

FIG. 3 is an isometric drawing of the extended frame as in FIG. 2, but shows the position and mechanism of the carriage rack which is used for the transport of items not normally carried in the bags shown in FIG. 4.

FIG. 4 is an isometric drawing of the extended frame of the trolley and the positioning of the carry bags hereinbefore mentioned.

FIG. 5 to FIG. 37D shows various aspects of the invention.

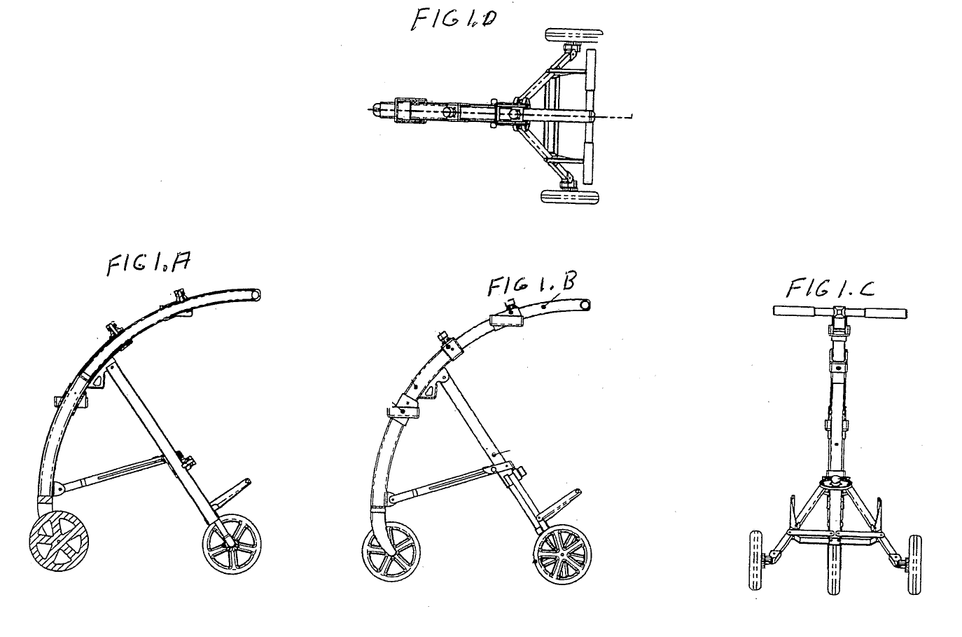

### DETAILED DESCRIPTION

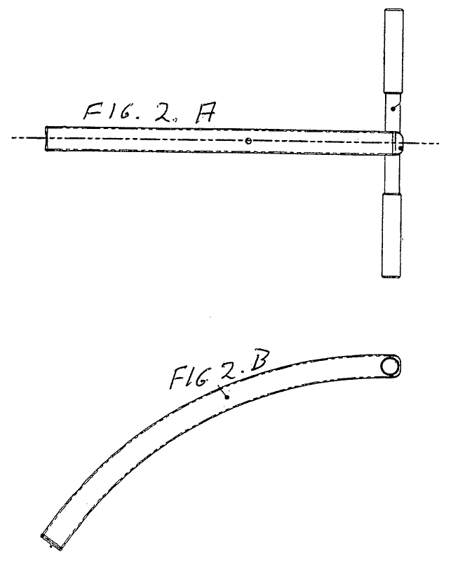

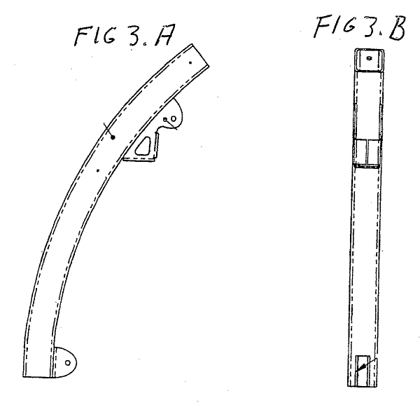

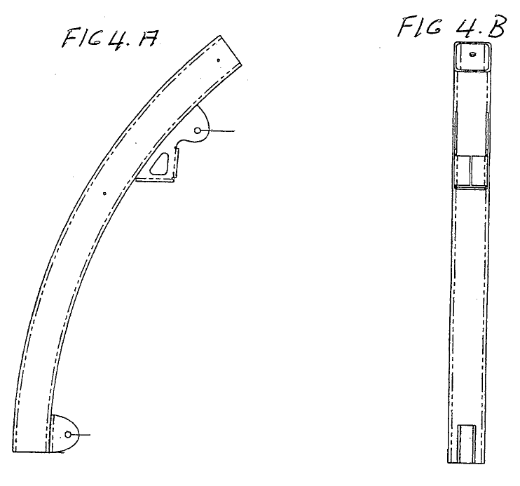

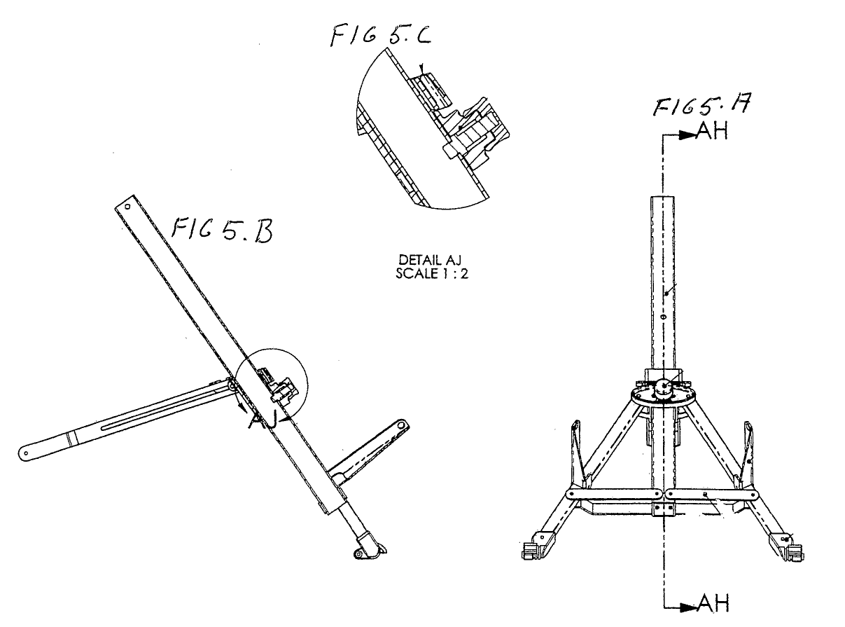

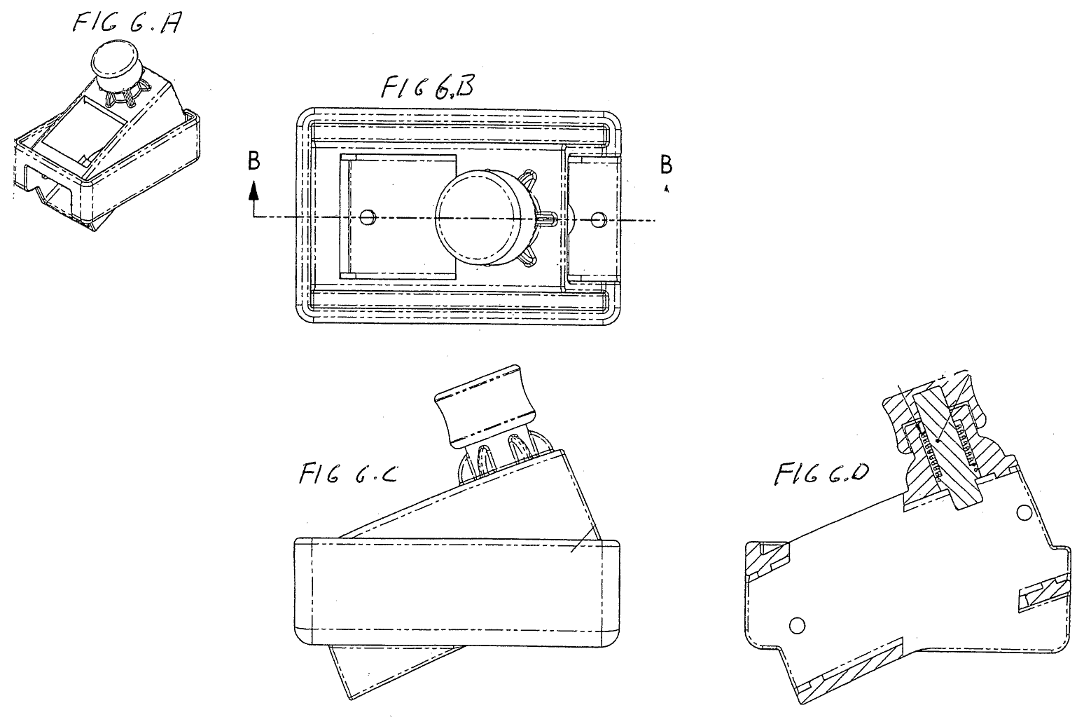

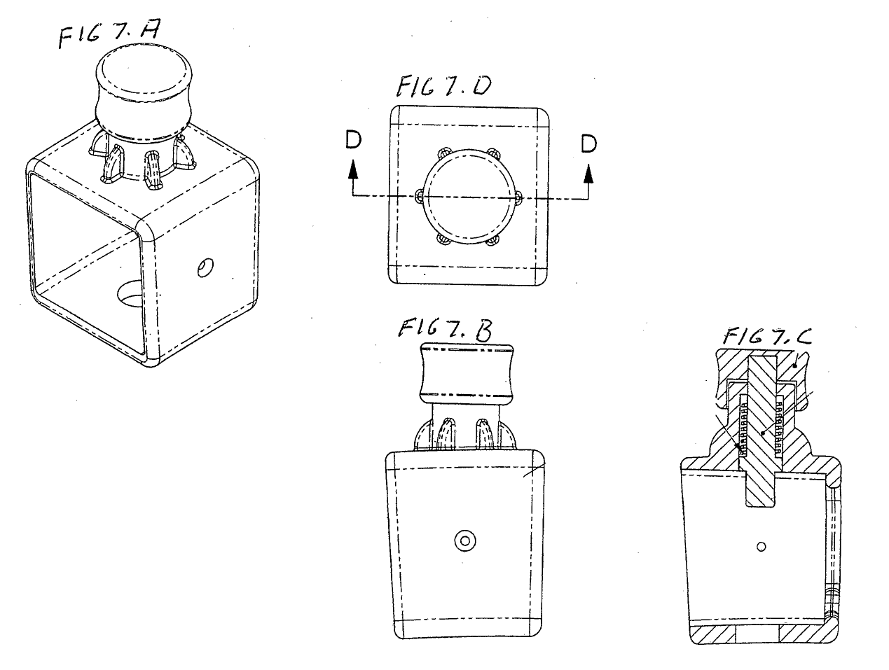

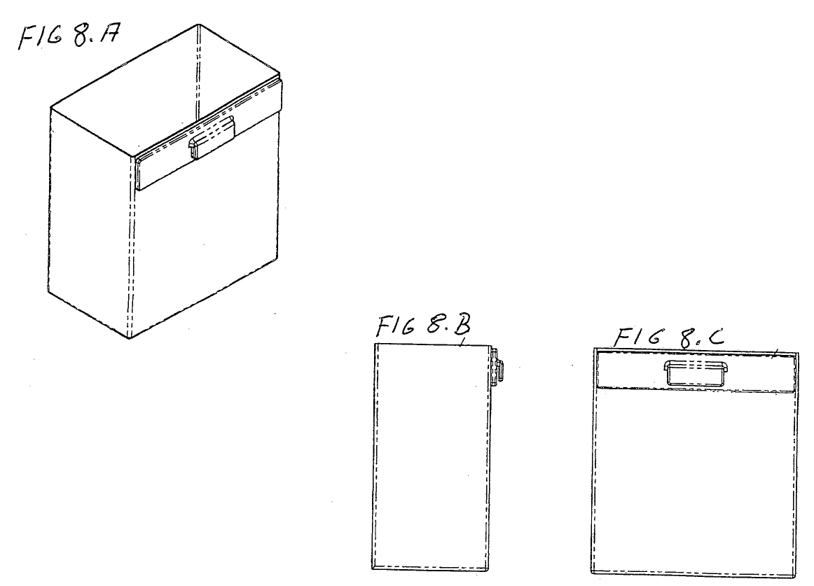

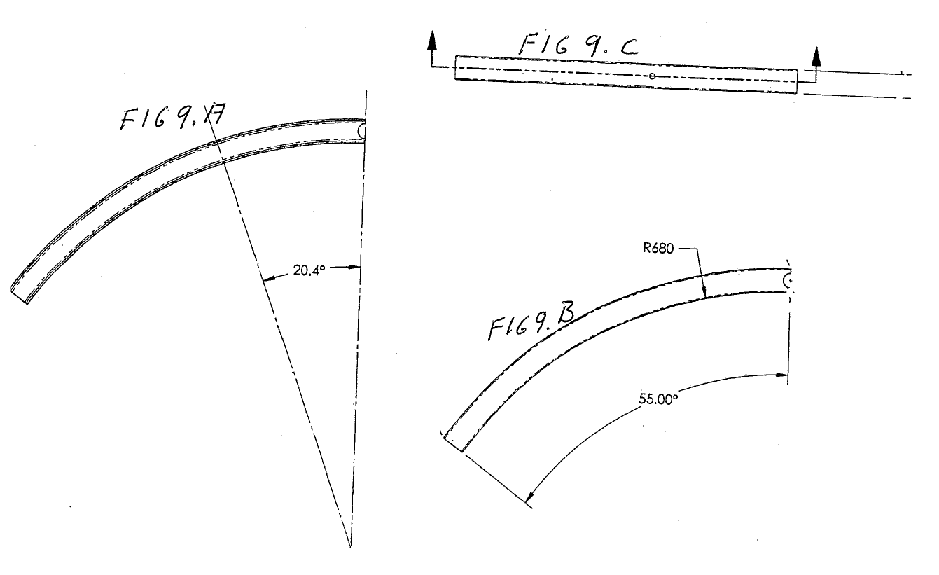

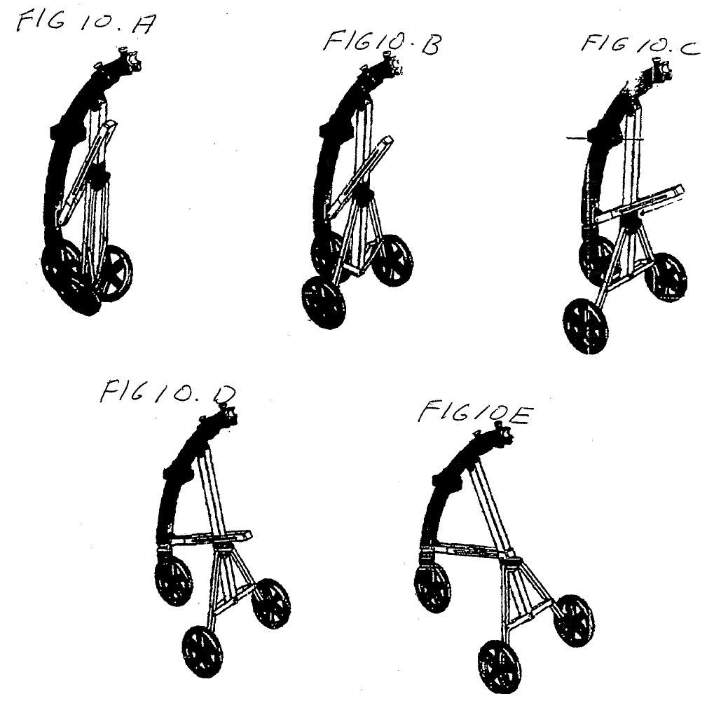

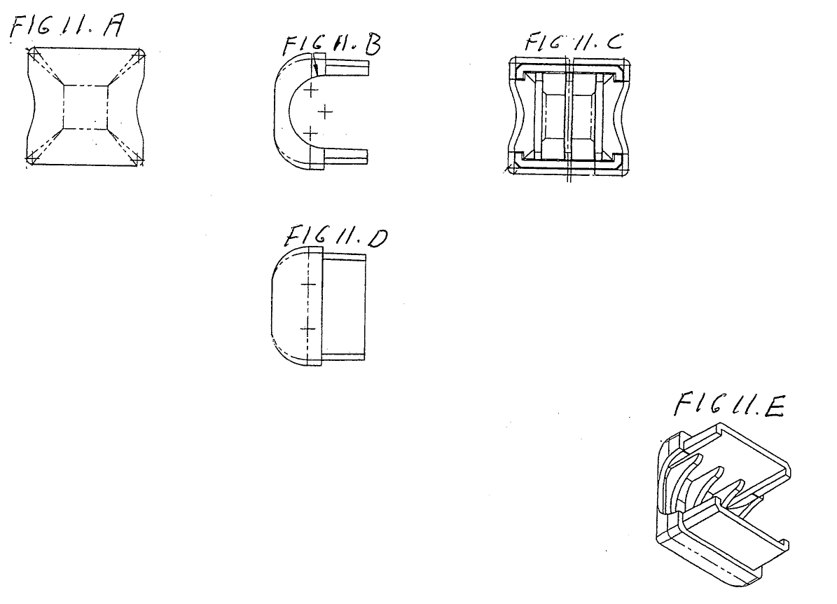

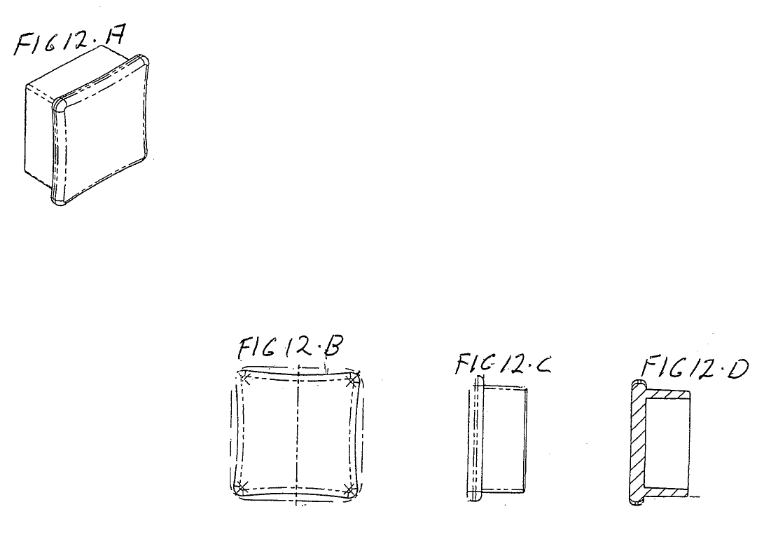

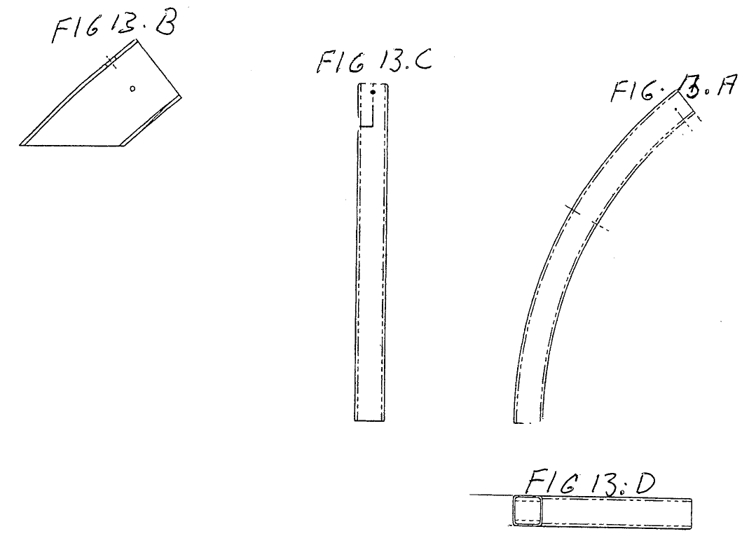

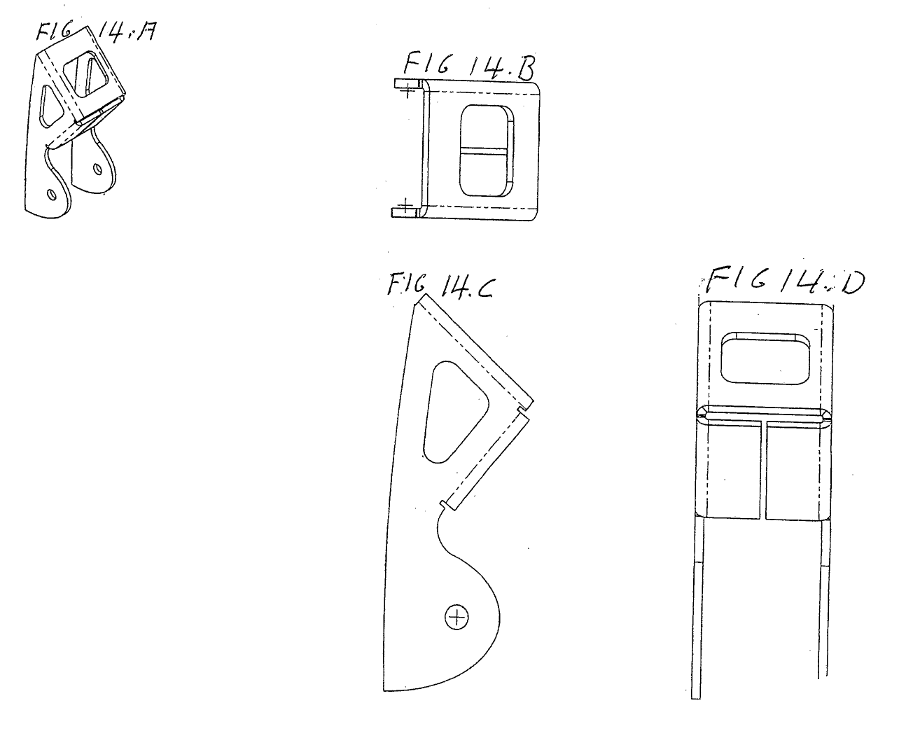

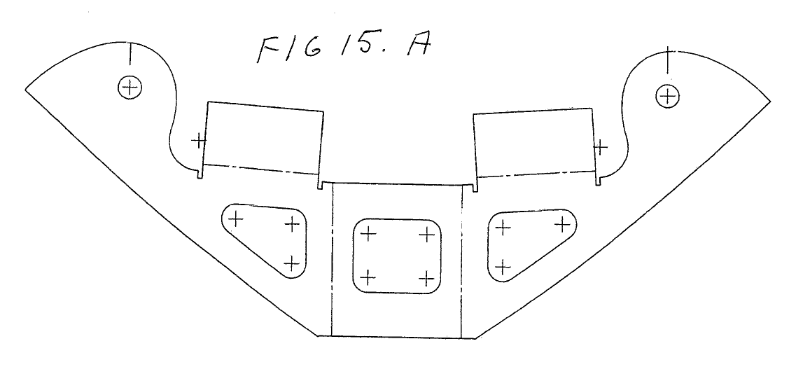

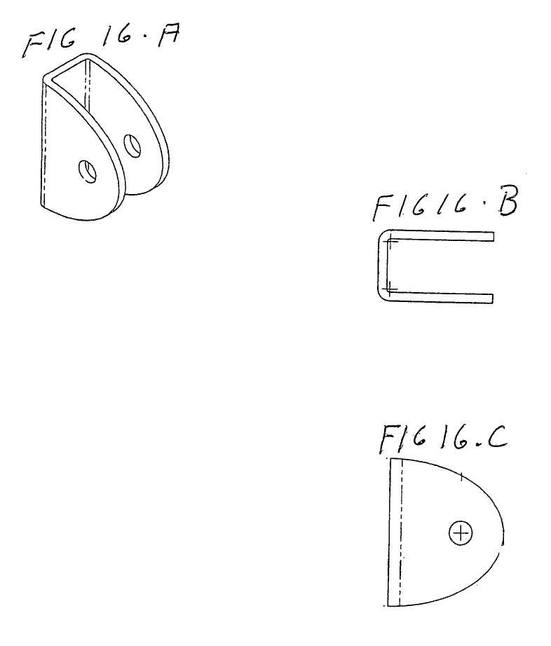

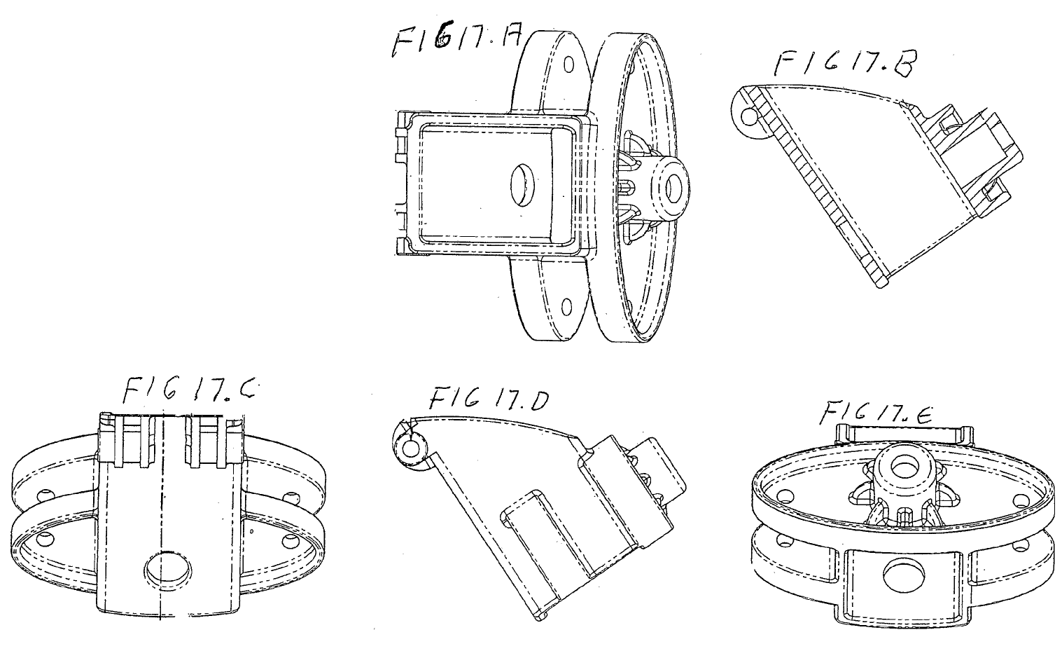

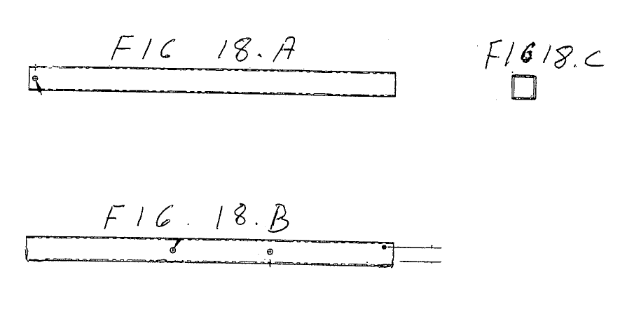

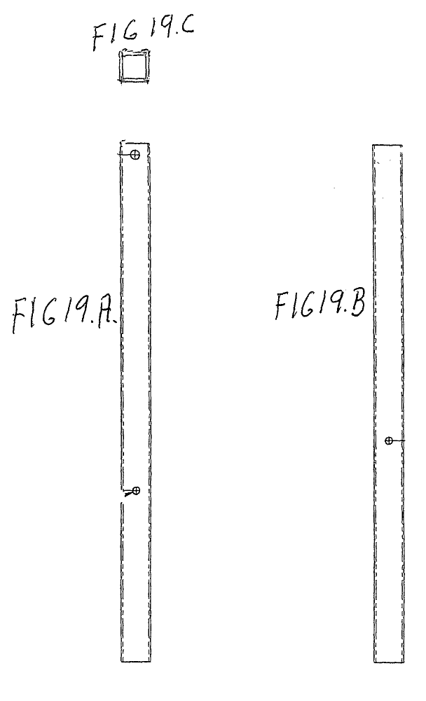

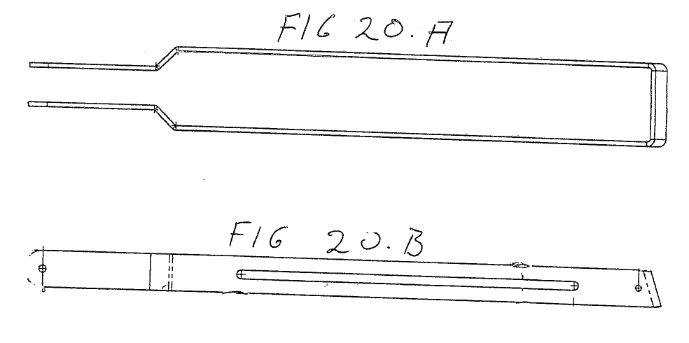

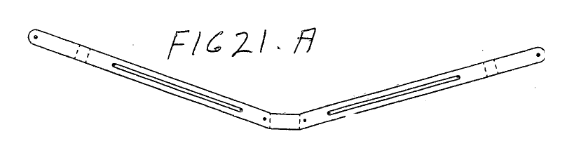

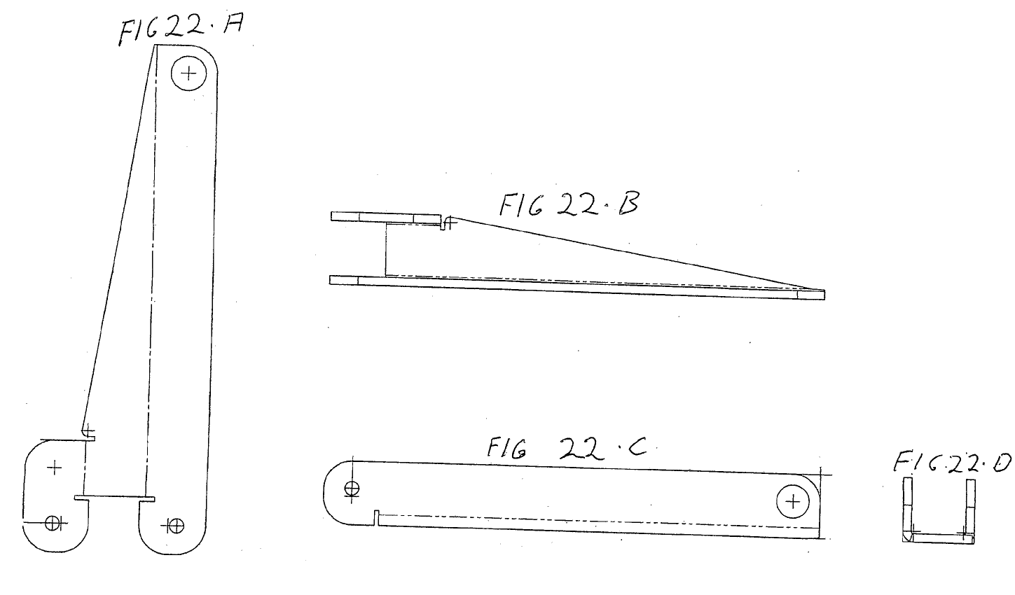

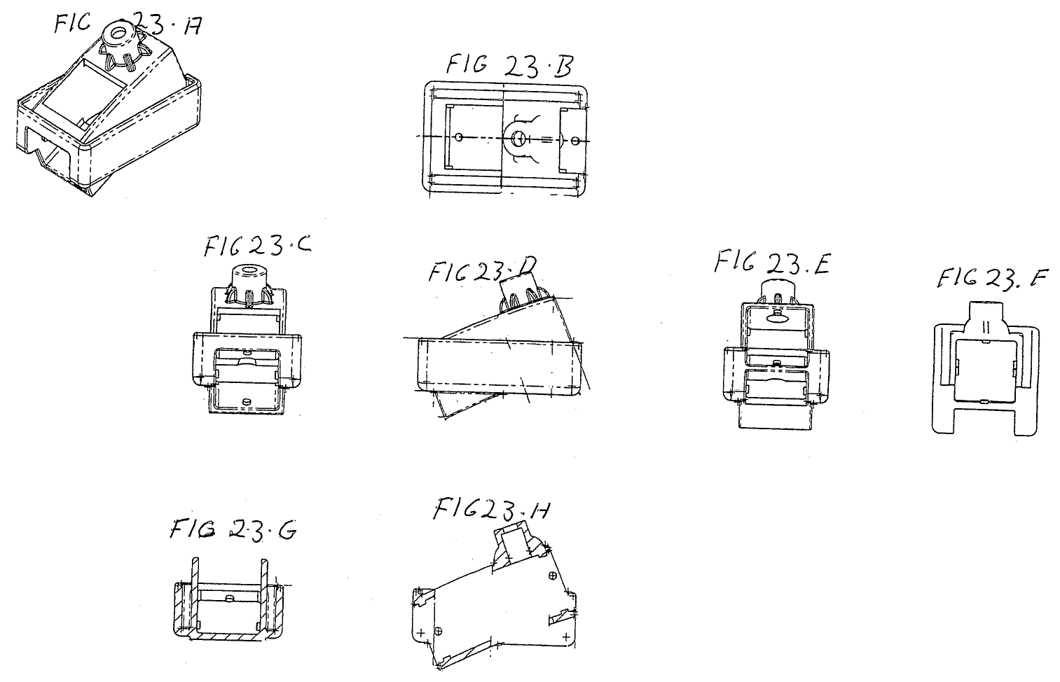

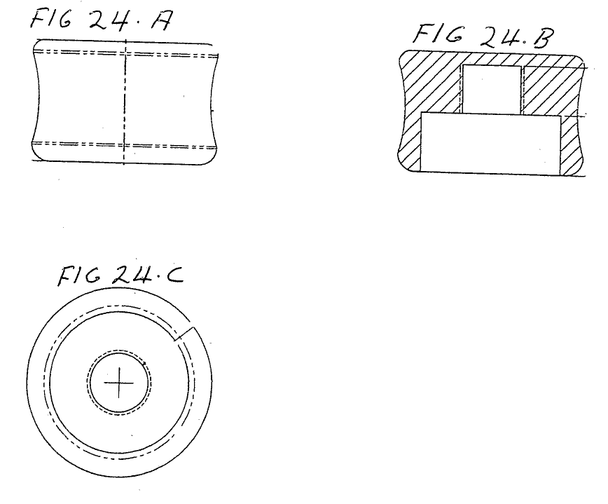

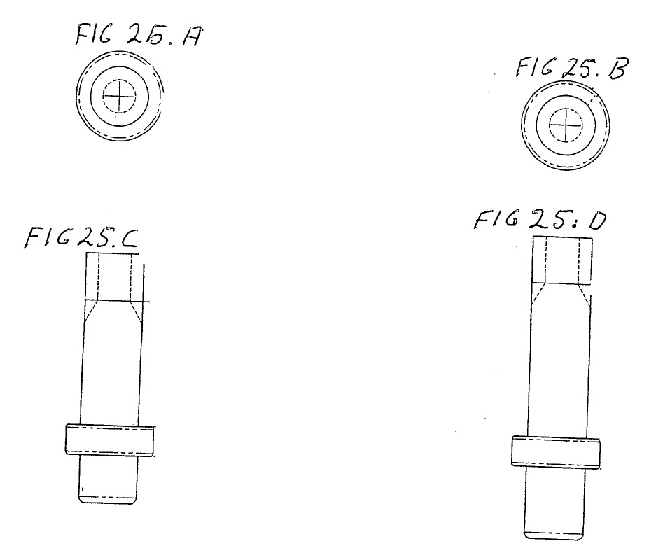

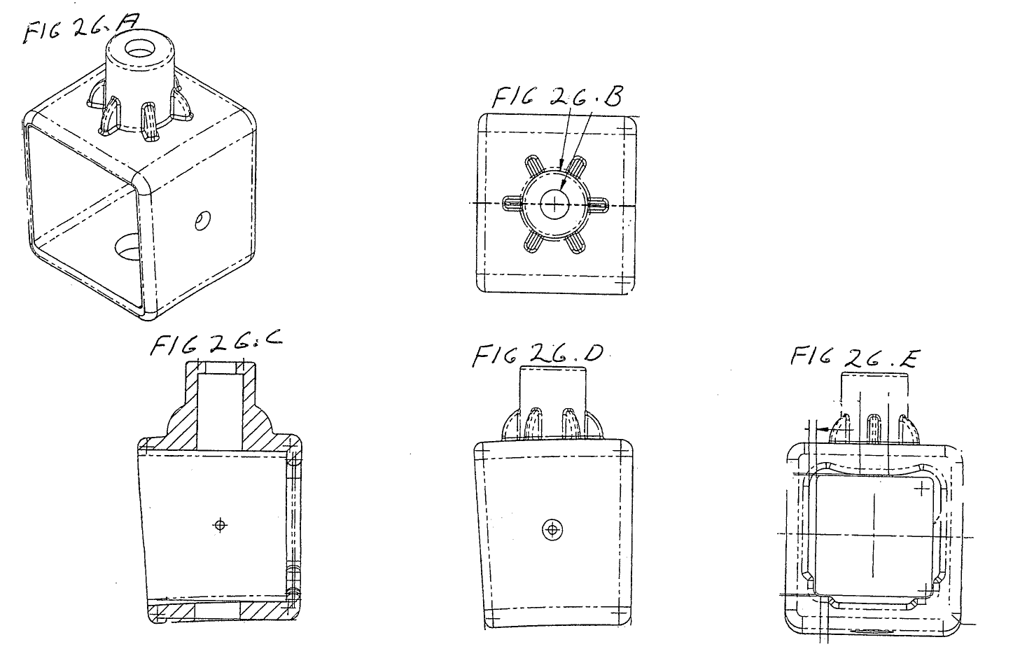

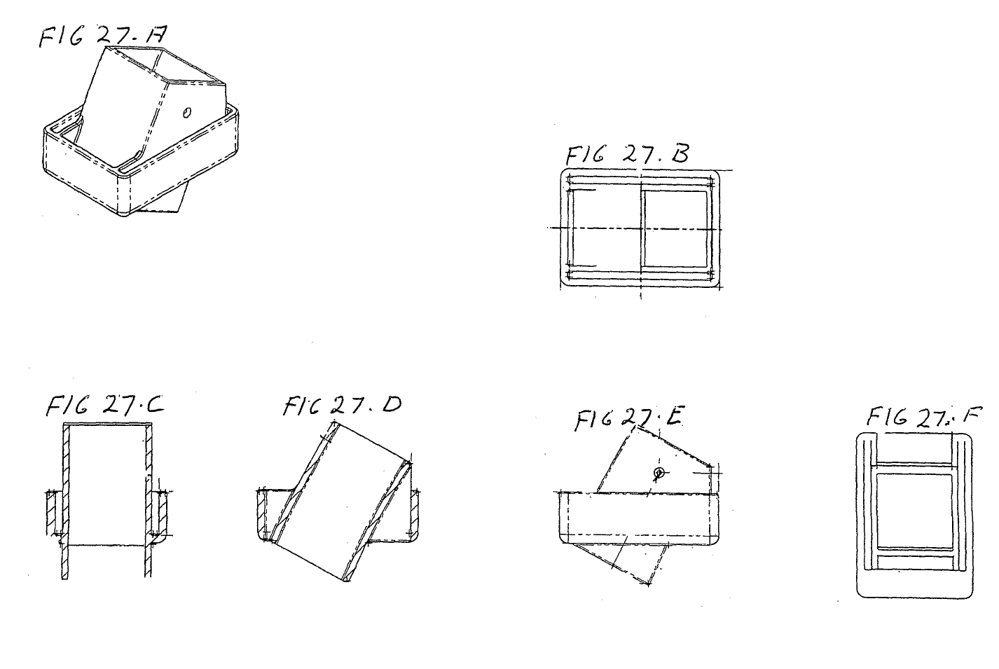

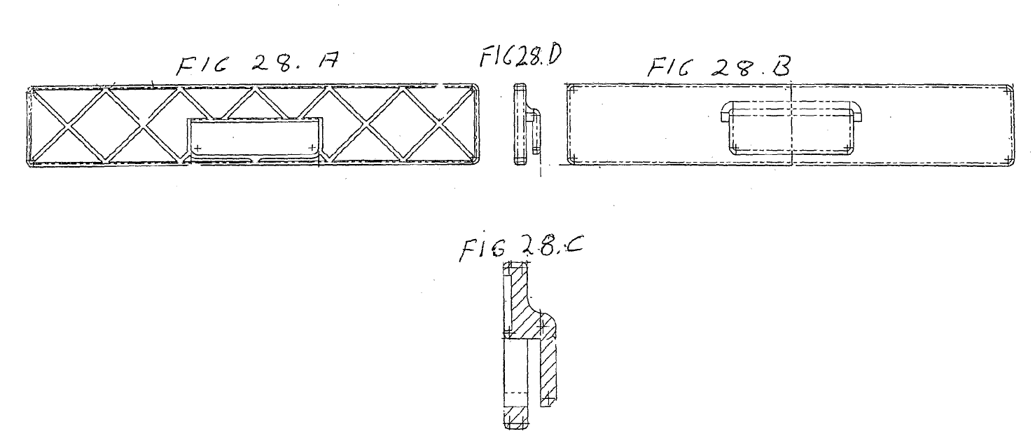

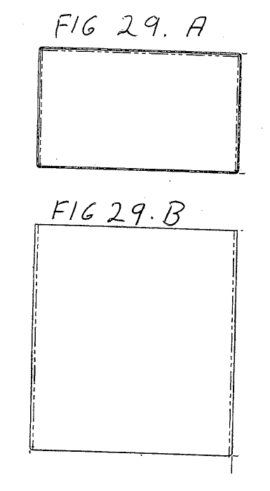

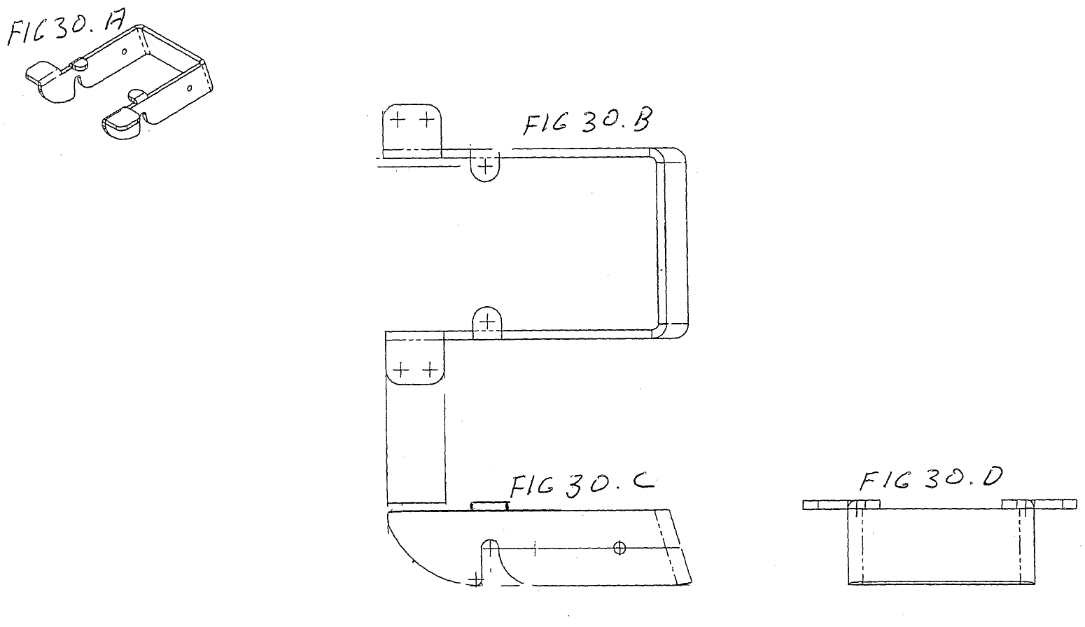

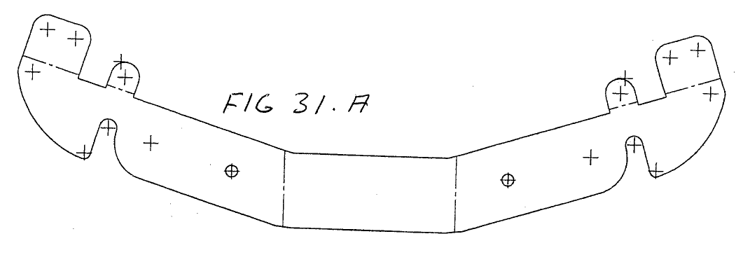

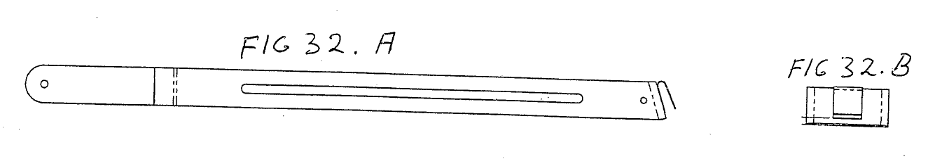

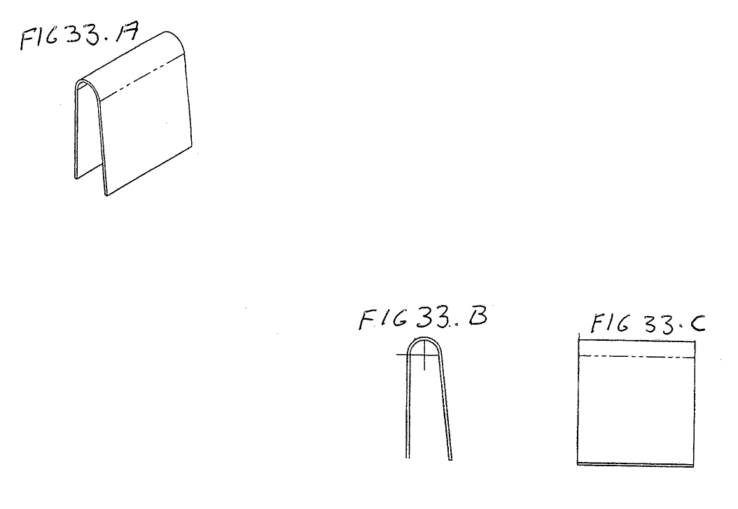

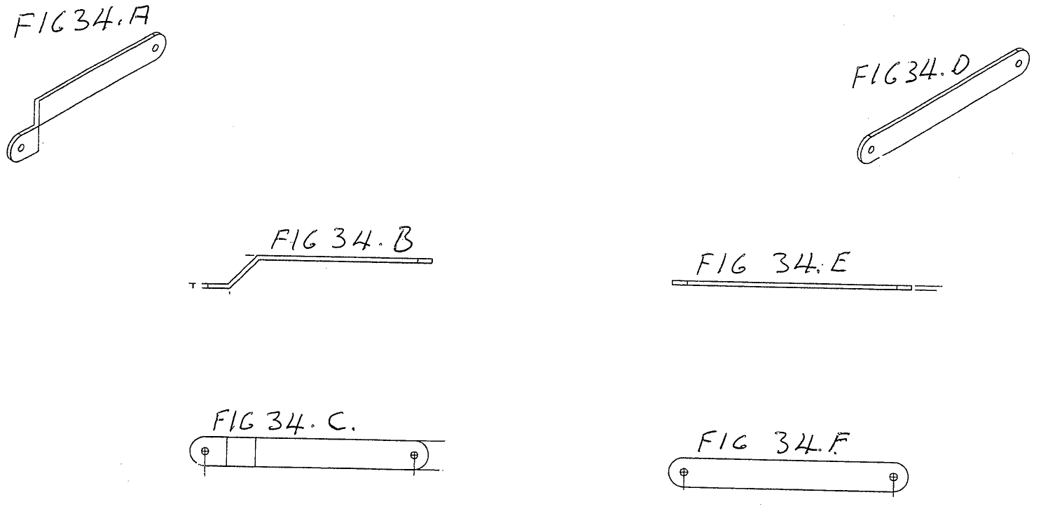

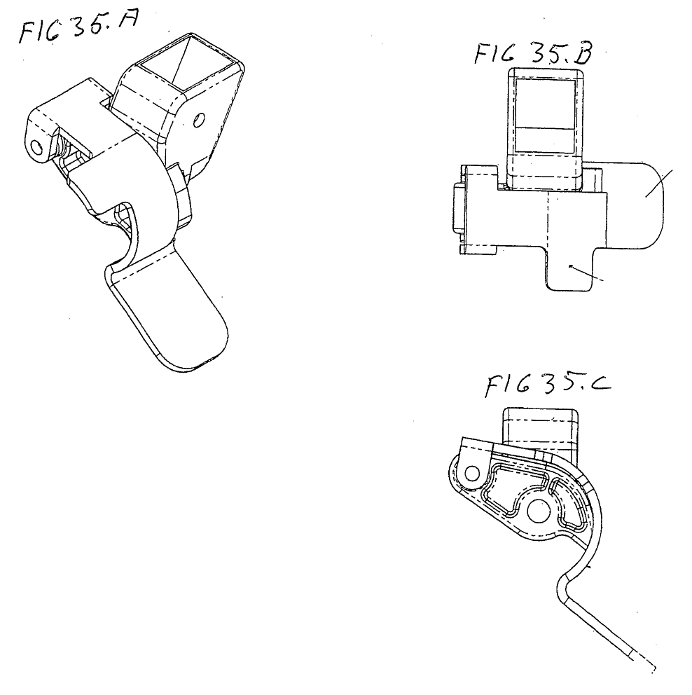

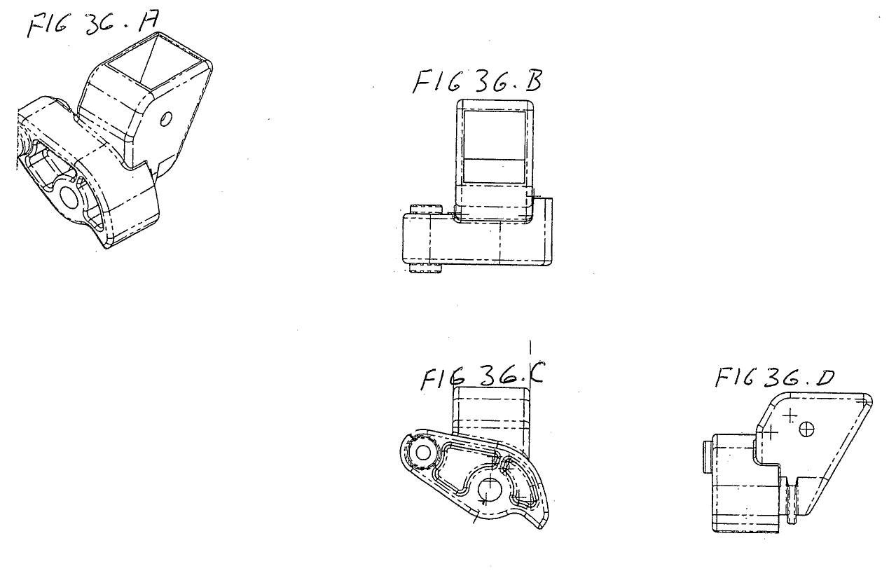

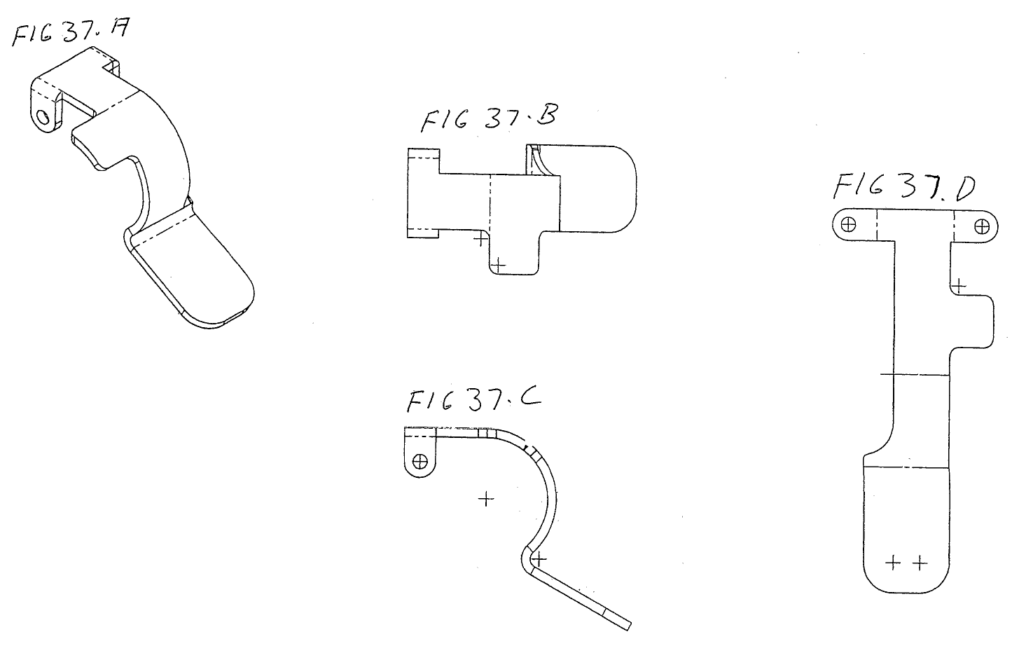

The Carry-Master Trolley invention comprises a folding telescoping frame connected to 3 oversized wheels and a handle bar attached to the top section of the telescopic frame (as in FIG. 2), the combination of which makes controlling and maneuvering of the trolley easy. The 2 rear wheels have a locking mechanism which allows the trolley to remain in position on sloping surfaces. The telescopic frame is curved and the length of the curve is an actual segment of a circle. Such segment can be part of a circle of any nominated radius, and thus the height of the handle at the top end of the frame, can be adjusted by altering the radius of the segment initially at manufacture. Further height adjustment is possible by adjusting the length of the telescopic sections of the frame.

In accordance with this invention the frame is surrounded by carry bags. There is also the facility of an added carriage rack which is attached to the frame. This invention has been specially devised in order to allow shoppers to separate their groceries into the large individual bags. This invention prevents items from being squashed or contaminated by other products carried in the trolley.

In accordance with the invention, the bags (shown in Figure) have a side support bar attached horizontally to one top side. Connected to this side support bar are protruding knobs which can be lowered onto corresponding notches in a saddle component of the upper portion of a folding telescopic frame. Thus the bags have been designed to be easily attached and detached from the notched saddle which is connected to the frame making it easy and quick to load and unload the goods or groceries held in the bag, thus allowing for quicker movement through checkout lines. The ease of use of the bags will benefit both the shopper and the cashier as the bags also have a small loop attached to their tops which fits easily onto cashiers (bag holder) apparatus. A carry handle which is capable of supporting the loaded weight of the bag and has a grip that is comfortable to hold is also attached to the reinforced section of the top of each bag.

The invention conforms to the requirements of the standards entitled AS/NZS 3847.1.1.1999 Shopping Trolleys for General Use, however the trolley invention is not limited to use as a shopping trolley, and can have a multitude of uses where items have to be moved from one area to another within walking distance without the operator having to carry such loads (the weight of which can be up to the maximum carry weight of the invention, which can be varied by the type of materials used in its construction). With the manufacture of the invention using an aluminum frame it is envisaged that the maximum load will be 32 kilograms however different maximum load weights will be possible with different construction materials, so that the carrying of heavier weights would be possible if required.

A feature of the invention is its ability to perform its functions over the long term (when properly maintained and not overloaded past its maximum carry weight). The materials used in manufacture ensure that the invention will not rust. The trolley described in this invention is safe to use as the invention has no exposed or accessible sharp edges, points or burrs.

As the invention is very strong, robust, light in weight, easy to push, steer and pull. Its high maneuverability adds to the user safety component of the invention. The invention combines materials in its manufacture that are recyclable.

1. A fold up or collapsible trolley comprises a frame configured to be folded or compacted into a smaller size when not in use.

2. A fold up or collapsible trolley comprising attachable bags able to be fitted to a frame of the trolley by plastic or metal holding clips sewn into one of the bags which has a side support bar attached horizontally to one top side, the side support bar having protruding knobs adapted to be lowered onto corresponding notches in a saddle component of an upper portion of a folding telescopic frame.

3. The fold up or collapsible trolley can according to any one of the preceding claims made from plastic, aluminium, carbon fibre, or steel.

4-9. (canceled)
